(19) United States
(12) Patent Application Publication
(10) Pub. No.: US 2020/0164461 A1
(43) Pub. Date: May 28, 2020

(54) HOLLOW STRUCTURE

(71) Applicant: SUMITOMO ELECTRIC INDUSTRIES, LTD., Osaka-shi, Osaka (JP)

(72) Inventors: Eisuke HIRO, Osaka-shi (JP); Masatada NUMANO, Osaka-shi (JP); Soichiro OKUMURA, Osaka-shi (JP)

(73) Assignee: SUMITOMO ELECTRIC INDUSTRIES, LTD., Osaka-shi, Osaka (JP)

(21) Appl. No.: 16/619,981

(22) PCT Filed: Jun. 21, 2018
(86) PCT No.: PCT/JP2018/023558

§ 371 Date: Dec. 6, 2019

(30) Foreign Application Priority Data
Jun. 26, 2017 (JP) 2017-124639
Nov. 22, 2017 (JP) 2017-224508

(51) Int. Cl. B23K 20/12

(52) U.S. Cl. CPC B23K 20/129; B23K 2103/10; B23K 20/1265

(57) ABSTRACT

A hollow structure includes: a main portion having an inner circumferential surface; and a flange portion including a first overhanging portion and a second overhanging portion that protrude outward from an outer circumference of the main portion and face each other. A first surface of the first overhanging portion and a second surface of the second overhanging portion are continuous with the inner circumferential surface, and the flange portion has a joint portion at which the first surface and the second surface are joined together. The main portion and the flange portion are formed of a metal material composed mainly of a light metal, and the formula ⅕<A/W1 is satisfied, where W1 is the width of the flange portion, and A is the width of the joint portion.

### TECHNICAL FIELD

The present invention relates to a hollow structure.

The present application claims priority from Japanese Patent Application No. 2017-124639 filed on Jun. 26, 2017 and Japanese Patent Application No. 2017-224508 filed on Nov. 22, 2017, the entire contents of which are incorporated herein by reference.

### BACKGROUND ART

One known hollow structure having a hollow closed cross-section portion is a cockpit support structure of a motor vehicle in PTL 1. This support structure includes a cross member having two tubular profiles (hollow closed cross-section portions) formed by extrusion. The tubular profiles arranged in their axial direction are welded together.

### CITATION LIST

### Patent Literature

PTL 1: Japanese Unexamined Patent Application Publication No. 2013-28337

### SUMMARY OF INVENTION

The hollow structure according to the present disclosure includes:

a main portion having an inner circumferential surface; and
a flange portion including a first overhanging portion and a second overhanging portion that protrude outward from an outer circumference of the main portion and face each other, wherein a first surface of the first overhanging portion and a second surface of the second overhanging portion are continuous with the inner circumferential surface, wherein the flange portion has a joint portion at which the first surface and the second surface are joined together,

wherein the main portion and the flange portion are formed of a metal material composed mainly of a light metal, and

wherein the formula ⅕<A/W1 is satisfied, where W1 is the width of the flange portion, and A is the width of the joint portion.

### BRIEF DESCRIPTION OF DRAWINGS

FIG. 1 is a perspective view showing a schematic of a hollow structure according to embodiment 1.

FIG. 2 is a cross-sectional view showing the state in which the hollow structure shown in FIG. 1 is cut along cutting-plane line (II)-(II).

FIG. 3 is an enlarged cross-sectional view of a flange portion included in the hollow structure according to embodiment 1.

FIG. 4 is a cross-sectional view showing a schematic of a hollow structure according to modification 1.

FIG. 5 is a cross-sectional view showing a schematic of a hollow structure according to modification 2.

FIG. 6 is a cross-sectional view showing a schematic of a hollow structure according to modification 3.

FIG. 7 is a cross-sectional view showing a schematic of a hollow structure according to modification 4.

FIG. 8 is a cross-sectional view showing a schematic of a hollow structure according to modification 5.

FIG. 9 is a cross-sectional view showing a schematic of a hollow structure according to modification 6.

FIG. 10 is a perspective view showing a schematic of a hollow structure according to modification 7.

FIG. 11 is a perspective view showing a schematic of a hollow structure according to modification 8.

FIG. 12 is a cross-sectional view showing the state in which the hollow structure shown in FIG. 11 is cut along cutting-plane line (XII)-(XII).

FIG. 13 is a cross-sectional view showing the state in which the hollow structure shown in FIG. 11 is cut along cutting-plane line (XIII)-(XIII).

FIG. 14 is a perspective view showing a schematic of a hollow structure according to modification 9.

FIG. 15 is a cross-sectional view showing the state in which the hollow structure shown in FIG. 14 is cut along cutting-plane line (XV)-(XV).

FIG. 16 is a cross-sectional view showing the state in which the hollow structure shown in FIG. 14 is cut along cutting-plane line (XVI)-(XVI).

FIG. 17 is a cross-sectional view showing a schematic of a hollow structure according to modification 10.

FIG. 18 is a cross-sectional view showing a schematic of a hollow structure according to modification 11.

FIG. 19 is a perspective view showing a schematic of a hollow structure according to modification 12.

FIG. 20 is a cross-sectional view showing the state in which the hollow structure shown in FIG. 19 is cut along cutting-plane line (XX)-(XX).

FIG. 21 is a perspective view showing a schematic of a hollow structure according to modification 13.

FIG. 22 is a cross-sectional view showing the state in which the hollow structure shown in FIG. 21 is cut along cutting-plane line (XXII)-(XXII).

FIG. 23 is a cross-sectional view showing a schematic of a hollow structure according to modification 14.

FIG. 24 is a cross-sectional view showing a schematic of a hollow structure according to modification 15.

FIG. 25 is a cross-sectional view showing a schematic of a hollow structure according to modification 16.

### DESCRIPTION OF EMBODIMENTS

### Problems to be Solved by Present Invention

When a welded portion is formed at a longitudinal position that divides a hollow structure, like the hollow structure disclosed in PTL 1, the welded portion may be a mechanical weak point. Therefore, the flexural rigidity of the hollow structure may be low.

One object is to provide a hollow structure excellent in flexural rigidity.

### Advantageous Effects of Present Invention

The hollow structure of the present disclosure is excellent in flexural rigidity.

### DESCRIPTION OF EMBODIMENTS OF PRESENT INVENTION

First, the details of embodiments of the present invention will be enumerated and described.

(1) A hollow structure according to one embodiment of the present invention includes:

a main portion having an inner circumferential surface; and

a flange portion including a first overhanging portion and a second overhanging portion that protrude outward from an outer circumference of the main portion and face each other,

wherein a first surface of the first overhanging portion and a second surface of the second overhanging portion are continuous with the inner circumferential surface,

wherein the flange portion has a joint portion at which the first surface and the second surface are joined together,

wherein the main portion and the flange portion are formed of a metal material composed mainly of a light metal, and

wherein the formula 1/5<A/W1 is satisfied, where W1 is the width of the flange portion, and A is the width of the joint portion.

The above configuration is excellent in flexural rigidity. This is because of the following reason. When the width ratio A/W1 satisfies the above range, the ratio of the joint portion in the flange portion can be increased, and the first overhanging portion and the second overhanging portion can be joined firmly together, so that the mechanical strength of the flange portion can be increased. Since the first overhanging portion and the second overhanging portion can be joined firmly together, the first overhanging portion and the second overhanging portion are unlikely to be separated due to application of external force.

(2) In one aspect of the hollow structure,

the flange portion may have a contact portion in which the first overhanging portion and the second overhanging portion are not joined together but are in contact with each other, and

the formula ¼<A/W2 may be satisfied, where W2 is the sum of the width A of the joint portion and the width of the contact portion.

In the above configuration, since the width of the joint portion is large, the first overhanging portion and the second overhanging portion can be joined more firmly together, so that higher flexural rigidity is obtained.

(3) In one aspect of the hollow structure having the contact portion,

the contact portion may include an inner contact portion formed closer to the main portion than the joint portion, and

the formula B/W2<⅗ may be satisfied, where B is the width of the inner contact portion.

In the above configuration, since the width of the contact portion is small, the ratio of the joint portion in the flange portion can be increased, so that higher flexural rigidity can be obtained.

(4) In one aspect of the hollow structure, the length of the joint portion may be 30% or more of the total length of the flange portion.

In the above configuration, since the length of the joint portion is large, the first overhanging portion and the second overhanging portion can be joined more firmly together over a wide area in the longitudinal direction of the flange portion.

(5) In one aspect of the hollow structure, the joint portion may include a friction stir welded portion at which the first overhanging portion and the second overhanging portion are joined together by friction stir welding.

In the above configuration, since the first overhanging portion and the second overhanging portion are joined firmly at the friction stir welded portion, excellent flexural rigidity is obtained.

(6) In one aspect of the hollow structure, the hollow structure may have at least one of an enlarged portion in which a space formed by the inner circumferential surface has a locally larger cross-sectional area and a reduced portion in which the space formed by the inner circumferential surface has a locally smaller cross sectional area.

When the enlarged portion is provided, the mechanical strength can be easily increased locally, and a peripheral member can be easily connected to the hollow structure using the enlarged portion. When the reduced portion is provided, a peripheral member can be disposed in the reduced portion, and therefore the hollow structure is unlikely to interfere with the peripheral member, so that space saving can be achieved easily.

(7) In one aspect of the hollow structure, the flange portion may include a wide portion in which the flange portion has a locally larger width.

In the above configuration, the mechanical strength of the flange portion can be easily increased locally.

(8) In one aspect of the hollow structure, the flange portion may have a notch.

In the above configuration, a peripheral member can be disposed in the notch, and therefore the hollow structure is unlikely to interfere with the peripheral member, so that space saving can be achieved easily.

(9) In one aspect of the hollow structure, the light metal may be magnesium or aluminum.

When the light metal is magnesium, the hollow structure is lightweight and is excellent not only in flexural rigidity but also in impact resistance.

When the light metal is aluminum, the hollow structure is lightweight and is excellent in mechanical strength, and its shape flexibility can be easily increased.

(10) In one aspect of the hollow structure, the light metal may be an AZ91 alloy.

When the light metal is a Mg alloy, i.e., a Mg-based alloy containing magnesium as a main component, the hollow structure has high specific strength, is excellent in corrosion resistance and mechanical properties, is lightweight, and is excellent in flexural rigidity and impact resistance.

### Details of Embodiments of Present Invention

Referring next to the drawings, embodiments of the present invention will be described in detail. In the drawings, the same numerals denote components with the same names.

### Embodiment 1

### [Hollow Structure]

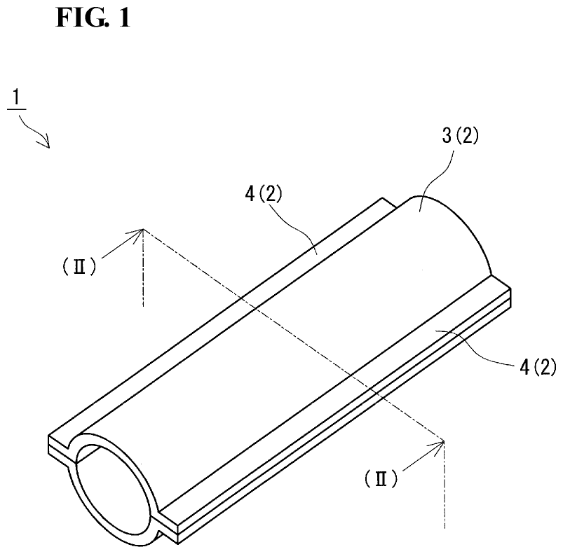

Referring to FIGS. 1 to 3, a hollow structure 1 according to embodiment 1 will be described. The hollow structure 1 according to embodiment 1 has a hollow closed cross-section portion 2. One feature of the hollow structure 1 is that the hollow closed cross-section portion 2 includes flange portions 4 each having a first overhanging portion 41 and a second overhanging portion 42 that protrude outward and each further having a joint portion 5 that has a specific width and joins the first overhanging portion 41 and the second overhanging portion 42 together. The details will next be described.

### [Hollow Closed Cross-Section Portion]

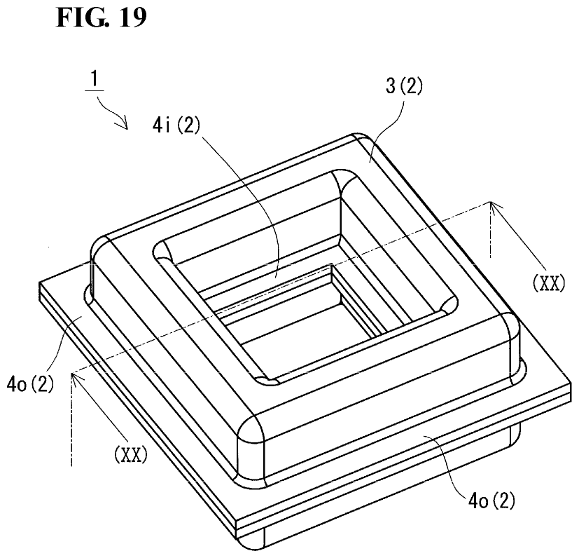

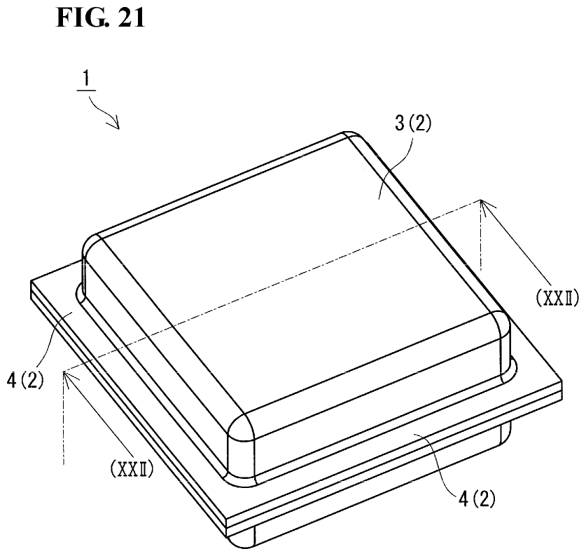

The hollow closed cross-section portion 2 forms a hollow space thereinside. The hollow closed cross-section portion 2 has a cross section with a closed inner side. The inner space of the hollow closed cross-section portion 2 is a space formed by its inner circumferential surface. The hollow closed cross-section portion 2 can have a shape appropriately selected according to its intended application. In the present example, the hollow closed cross-section portion 2 is an elongated tubular body (FIG. 1) but may be an annular body (FIG. 19) or a box-shaped body (FIG. 21) described later. The elongated tubular body in the present example has a linear shape extending in its longitudinal direction but may have an arcuate shape, a meandering shape, or an L or U shape with a bent portion bent from the longitudinal direction. The annular body may be a circular or elliptical annular body having a circular or elliptical projection shape or a polygonal annular body having, for example, a rectangular projection shape, as viewed in the axial direction of the annular body. The box-shaped body may have a cylindrical shape or a prismatic shape. The hollow closed cross-section portion 2 includes a main portion 3 and the flange portions 4.

### (Main Portion)

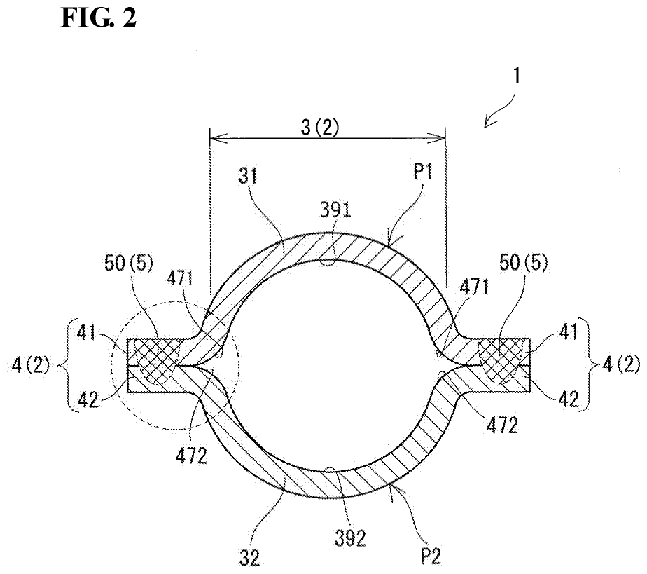

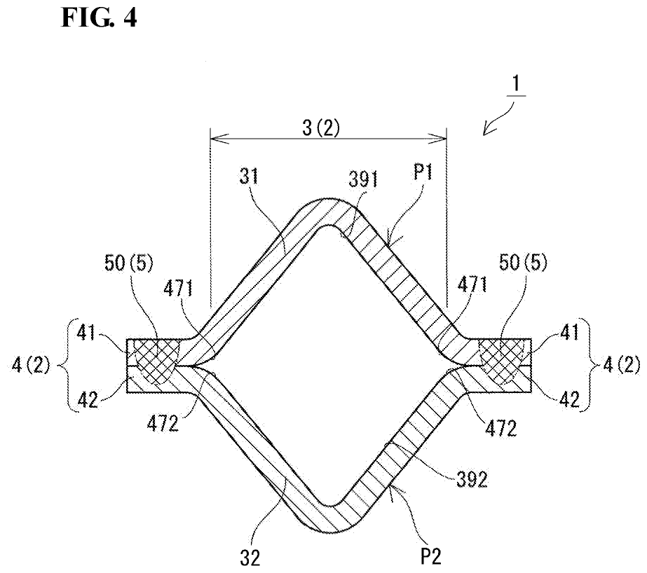

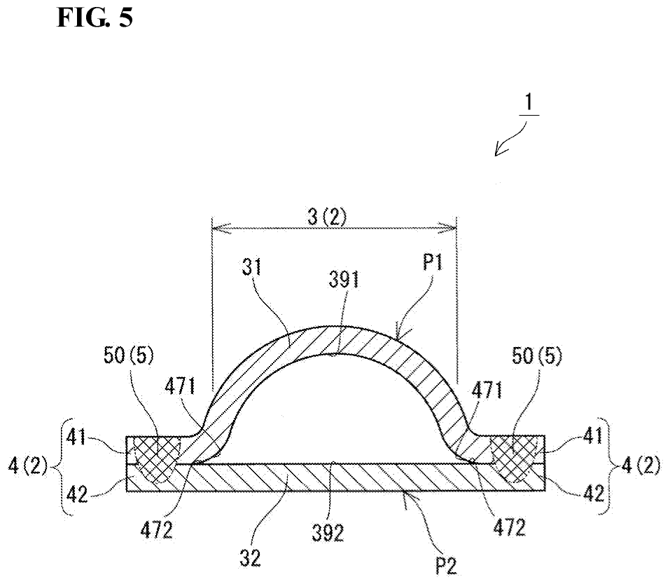

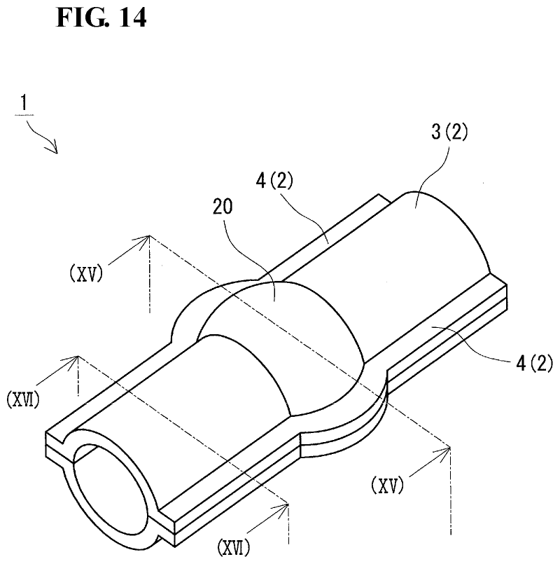

The main portion 3 is part of the hollow closed cross-section portion 2 excluding the flange portions 4 and substantially forms the inner space of the hollow closed cross-section portion 2. The inner space of the main portion 3 is a space formed by the inner circumferential surface of the main portion 3. The cross section of the inner space of the main portion 3 has a circular annular shape (a circular shape (FIG. 2)) in the present example but may have a semi-circular annular shape (a semi-circular shape (FIG. 5)), an elliptical annular shape (an elliptical shape (not shown)), or a polygonal annular shape (a polygonal shape) such as a rectangular annular shape (a rectangular shape (FIG. 4)). The cross-sectional shape of the main portion 3 is uniform in the axial direction of the hollow closed cross-section portion 2 in the present example but may include a plurality of different shapes. For example, the main portion 3 may include a portion having a circular annular cross-sectional shape and a portion having a rectangular cross-sectional shape. The cross-sectional shape of the inner space of the main portion 3 may have a uniform size in the axial direction or may include portions with different sizes. For example, the main portion 3 may have at least one of an enlarged portion 20 (FIG. 14) having a locally larger cross-sectional area and a reduced portion (not shown) having a locally smaller cross-sectional area.

### (Flange Portions)

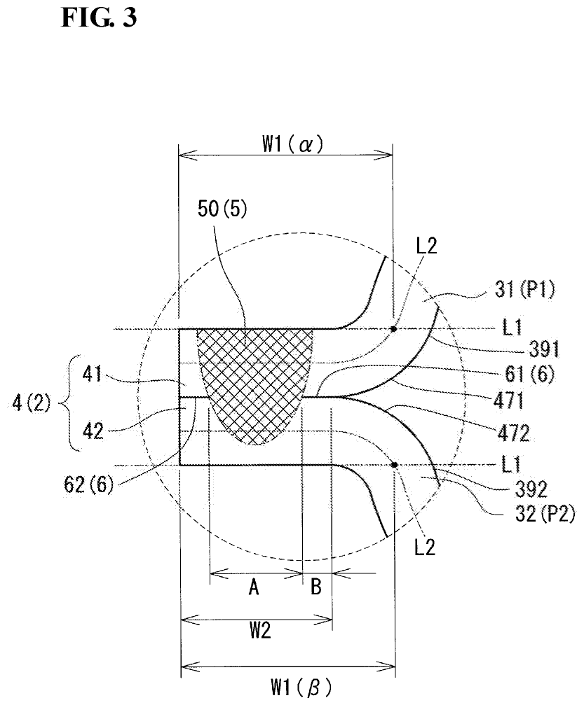

The flange portions 4 included in the hollow closed cross-section portion 2 are portions protruding outward and increase the flexural rigidity of the hollow closed cross-section portion 2. The flange portions 4 include the respective first overhanging portions 41 and the respective second overhanging portions 42. The flange portions 4 include the respective joint portions 5 (FIGS. 2 and 3). The flange portions 4 may further include contact portions 6 (FIG. 3).

The flange portions 4 typically have a rectangular cross-sectional shape, and the shape of the flange portions 4 in plan view is typically rectangular. The dimensions (length, width W1, and thickness) of the flange portions 4 may be appropriately selected.

The larger the length of the flange portions 4 in the axial direction of the hollow closed cross-section portion 2, the more easily the flexural rigidity of the hollow closed cross-section portion 2 can be increased. In the present example, the formation regions (lengths) of the flange portions 4 that extend in the axial direction of the hollow closed cross-section portion 2 are axial regions (lengths) extending over the entire length of the hollow closed cross-section portion 2 in the axial direction (FIG. 1) but may be at least part of the axial regions (lengths). When the formation regions of the flange portions 4 are part of the axial regions of the hollow closed cross-section portion 2, each flange portion 4 may be, for example, divided into a plurality of portions arranged in the axial direction of the hollow closed cross-section portion 2. In this case, a region in which no flange portion 4 is formed and only the main portion 3 is present is present between divided portions of the flange portion.

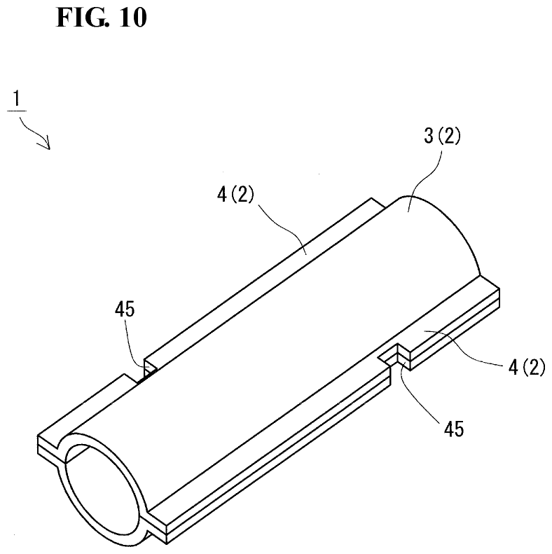

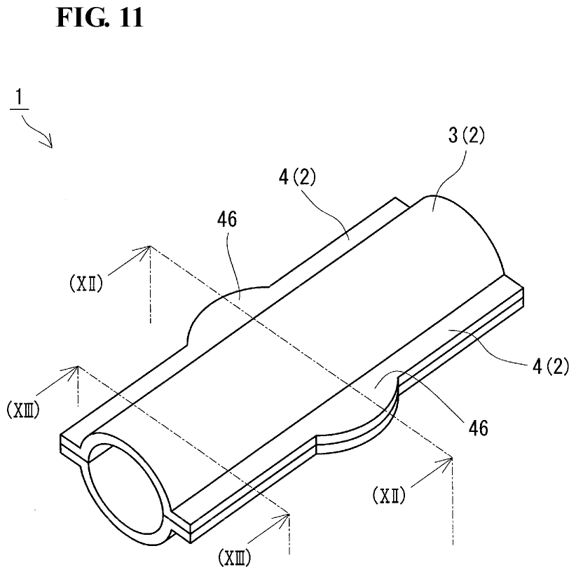

The width W1 of each flange portion 4 (FIG. 3) is uniform in the longitudinal direction of the flange portion 4 in the present example but may vary in the longitudinal direction. When the flange portion 4 has different widths, the flange portion 4 may have, for example, at least one of a narrow portion having a locally smaller width (a notch 45 (FIG. 10)) and a wide portion 46 (FIG. 11) having a locally larger width W1. The width W1 of the flange portion 4 is the shorter one of width α and width β described below. When the width α is equal to the width β, the width W1 of the flange portion 4 may be any of the width α and the width β. The width α is the length of a portion parallel to the surface of the first overhanging portion 41 and located between the side surface of the first overhanging portion 41 and the intersection of a virtual line L1 extending along the surface of the first overhanging portion 41 and a bisector L2 of the thickness of the first overhanging portion 41 (FIG. 3). The width β is the length of a portion parallel to the surface of the second overhanging portion 42 and located between the side surface of the second overhanging portion 42 and the intersection of a virtual line L1 extending along the surface of the second overhanging portion 42 and a bisector L2 of the thickness of the second overhanging portion 42 (FIG. 3). In the present example, the width α is equal to the width β, as shown in FIG. 3.

In the present example, the thickness of each flange portion 4 is uniform in the longitudinal direction, but the flange portion 4 may have different thicknesses.

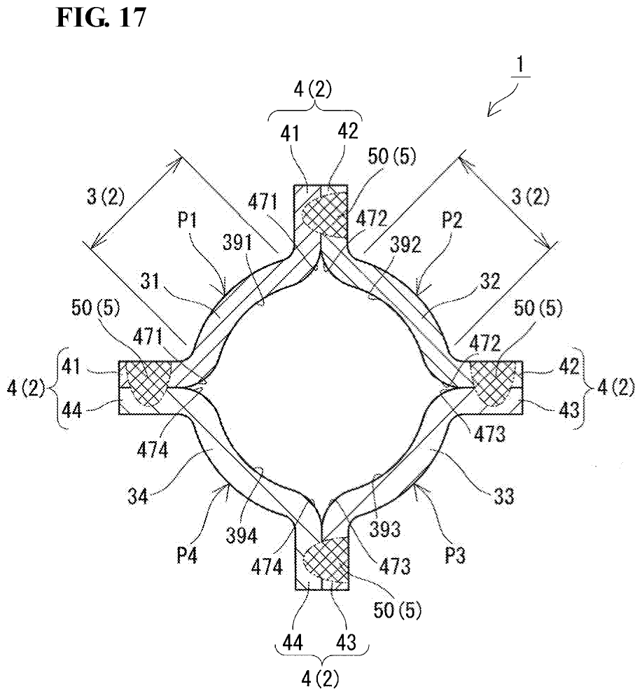

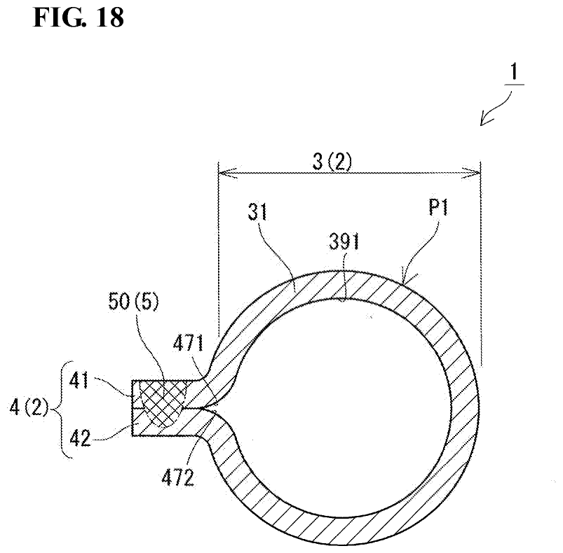

The number of flange portions 4 is two (plural) in the present example but may be three or more (four in FIG. 17) or, of course, 1 (FIG. 18).

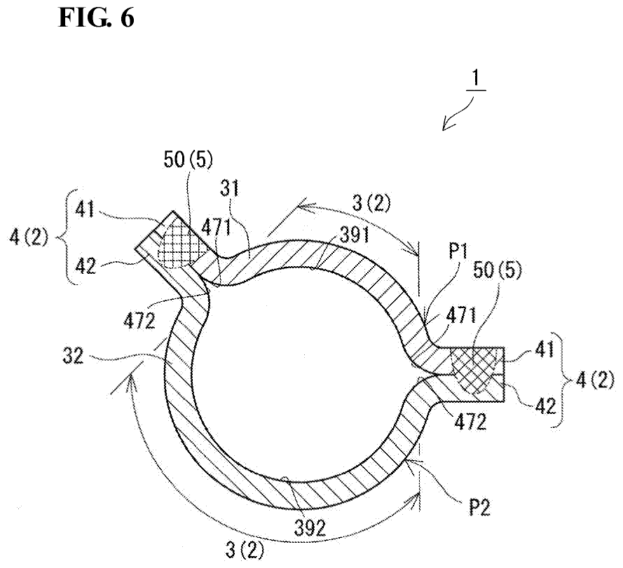

When the number of flange portions 4 is plural, the formation positions of the flange portions 4 that are arranged in the circumferential direction of the hollow closed cross-section portion 2 may be such that the clockwise circumferential distance between the flange portions 4 is equal to the counterclockwise circumferential distance between the flange portions 4 (FIG. 2), as in the present example. Alternatively, the clockwise circumferential distance between the flange portions 4 may differ from the counterclockwise circumferential distance between the flange portions 4 (FIG. 6). In the present example, the flange portions 4 are located in the same plane.

When the number of flange portions 4 is plural, the first overhanging portion 41 and the second overhanging portion 42 in each flange portion 4 may be composed of respective independent members. Specifically, the hollow closed cross-section portion 2 may be formed by combining the same number of split pieces (described later) as the number of flange portions 4.

When the number of flange portions 4 is one (FIG. 18), the first overhanging portion 41 and the second overhanging portion 42 may be formed from a single member including a circumferential wall portion 31 forming the main portion 3 of the hollow closed cross-section portion 2. Specifically, the hollow closed cross-section portion 2 may be formed from one sheet. The details will be described later in modification 11.

In this example, the hollow closed cross-section portion 2 includes the main portion 3 and the two flange portions 4 and is composed of a combination of two plate-shaped split pieces (a first split piece P1 and a second split piece P2) having the same shape and the same size. The first split piece P1 includes: a circumferential wall portion 31 having a semi-circular arcuate cross section and a pair of first overhanging portions 41 having a rectangular cross section and protruding radially outward from opposite ends of the circumferential wall portion 31. The circumferential wall portion 31 has an inner circumferential surface 391, and each of the first overhanging portions 41 has a first surface 471 continuous with the inner circumferential surface 391. The second split piece P2 includes a circumferential wall portion 32 and a pair of second overhanging portions 42 similar to those of the first split piece P1. The circumferential wall portion 32 has an inner circumferential surface 392, and each of the second overhanging portions 42 has a second surface 472 continuous with the inner circumferential surface 392. In the hollow closed cross-section portion 2, one of the first overhanging portions 41 and one of the second overhanging portions 42 are disposed so as to face each other, and the other one of the first overhanging portions 41 and the other one of the second overhanging portions 42 are disposed so as to face each other. In this case, the first overhanging portions 41 and the second overhanging portions 42 are disposed such that the side surfaces of the first split piece P1 are aligned with the respective side surfaces of the second split piece P2. Specifically, the main portion 3 of the hollow closed cross-section portion 2 is composed of the circumferential wall portions 31 and 32. One of the flange portions 4 includes one of the first overhanging portions 41 and one of the second overhanging portions 42, and the other one of the flange portions 4 includes the other one of the first overhanging portions 41 and the other one of the second overhanging portions 42. The flange portions 4 have their respective joint portions 5.

### <Joint Portions>

Each joint portion 5 is formed by joining the first surface 471 of the corresponding first overhanging portion 41 and the second surface 472 of the corresponding second overhanging portion 42. In the present example, the joint portion 5 has a friction stir welded portion 50 formed by friction-stir-welding the material forming the first overhanging portion 41 and the material forming the second overhanging portion 42. The friction stir welded portion 50 can be formed by subjecting the first overhanging portion 41 and the second overhanging portion 42 stacked one on another to friction stir welding. Alternatively, for example, the joint portion 5 may have a laser joined portion formed by laser welding. The joint portion 5 in the present example is formed from the friction stir welded portion 50. The larger the formation region of the joint portion 5, the higher the joint strength between the first overhanging portion 41 and the second overhanging portion 42, and the higher the flexural rigidity of the hollow closed cross-section portion 2.

The width A of each joint portion 5 satisfies ⅕<A/W1, where W1 is the width of the corresponding flange portion 4. In this case, the ratio of the joint portion 5 in the flange portion 4 can be increased, and the first overhanging portion 41 and the second overhanging portion 42 can be joined firmly together. Since the mechanical strength of the flange portion 4 can be increased, the flexural rigidity of the hollow closed cross-section portion 2 can be increased. The width A of the joint portion 5 (FIG. 3) is the length of the flange portion 4 in a portion (the interface) that is located between the facing surface (rear surface) of the first overhanging portion 41 and the facing surface (rear surface) of the second overhanging portion 42 and is parallel to the width W1. The width ratio A/W1 satisfies preferably ¼≤A/W1 and particularly preferably ⅓≤A/W1.

Let the sum of the width A of the joint portion 5 and the width of a contact portion 6 described later be W2. Then it is preferable that the width of the joint portion 5 satisfies ¼<A/W2. In this case, the flexural rigidity of the hollow closed cross-section portion 2 can be further increased. The width of the contact portion 6 is the width of a portion in which the first overhanging portion 41 and the second overhanging portion 42 are not joined (friction-stir-welded in this case) but are in contact with each other. The width ratio A/W2 satisfies preferably ⅓≤A/W2 and particularly preferably ⅖≤A/W2.

Preferably, the length of the joint portion 5 is 30% or more of the length of the flange portion 4. In this case, the flexural rigidity of the hollow closed cross-section portion 2 can be further increased. The length of the joint portion 5 and the length of the flange portion 4 are their lengths in the axial direction of the hollow closed cross-section portion 2. The longer the length of the joint portion 5, the further the flexural rigidity of the hollow closed cross-section portion 2 can be increased. Therefore, the length of the joint portion 5 is preferably 40% or more of the length of the flange portion 4 and particularly preferably 50% of more of the length of the flange portion 4. The joint portion 5 may be formed continuously in the longitudinal direction of the flange portion 4 or may be formed intermittently. When the joint portion 5 is formed intermittently, the length of the joint portion 5 is the total length of the intermittently formed portions.

### <Contact Portions>

Each contact portion 6 is a portion in which the corresponding first overhanging portion 41 and the corresponding second overhanging portion 42 are not joined (friction-stir-welded in this case) but are in contact with each other. The contact portion 6 includes an inner contact portion 61 formed inward (on the main portion side) of the corresponding joint portion 5. Preferably, the width B of the inner contact portion 61 satisfies B/W2<⅗. In this case, the ratio of the joint portion 5 in the flange portion 4 can be increased, so that the flexural rigidity of the hollow closed cross-section portion 2 can be increased. The width ratio B/W2 satisfies preferably B/W2≤½ and particularly preferably B/W2≤⅖. The lower limit of the width ratio B/W2 is about 1/10. The contact portion 6 is allowed to include an outer contact portion 62 formed outward of the joint portion 5.

The material forming the hollow closed cross-section portion 2 may by a metal material containing a light metal as a main component. Specific examples of the metal material include Mg (magnesium)-based materials containing magnesium as a main component and Al (aluminum)-based materials containing aluminum as a main component. Examples of the Mg-based material include pure Mg and Mg alloys, and examples of the Al-based material include pure Al and Al alloys. The Mg-based materials are lightweight and excellent in flexural rigidity and impact resistance. The Al-based materials are lightweight and excellent in mechanical strength, and the shape flexibility of the hollow closed cross-section portion 2 can be easily increased.

Examples of the Mg alloy include alloys having various compositions including Mg and additive elements (the valance: Mg and unavoidable impurities). It is particularly preferable to use a Mg—Al-based alloy containing at least Al as an additive element. As the content of Al increases, the corrosion resistance is further improved, and the mechanical properties such as strength and plastic deformation resistance tend to be further improved. Therefore, in the present invention, the content of Al is preferably 3% by mass or more, more preferably 7.3% by mass or more, and still more preferably 8% by mass or more. However, since an Al content exceeding 12% by mass causes deterioration of plastic formability, the upper limit is set to 12% by mass. The Al content is particularly preferably 11% by mass or less and still more preferably 8.3% by mass or more and 9.5% by mass or less.

The additive elements other than Al may include at least one element selected from Zn, Mn, Si, Be, Ca, Sr, Y, Cu, Ag, Sn, Ni, Au, Li, Zr, Ce, and rare earth elements (except for Y and Ce). When such elements are contained, their total content may be 0.01% by mass or more and 10% by mass or less and preferably 0.1% by mass or more and 5% by mass or less. When at least one additive element selected from Si, Sn, Y, Ce, Ca, and rare earth elements (except for Y and Ce) is contained in a total amount of 0.001% by mass or more and preferably 0.1% by mass or more and 5% by mass or less, excellent thermal resistance and flame resistance are obtained. When rare earth elements are contained, their total content is preferably 0.1% by mass or more. In particular, when Y is contained, its content is preferably 0.5% by mass or more. Examples of the impurities include Fe.

Specific examples of the composition of the Mg—Al-based alloy include the following alloys specified in the American Society for Testing and Materials standards: AZ-based alloys (Mg—Al—Zn-based alloys, Zn: 0.2% by mass or more and 1.5% by mass or less); AM-based alloys (Mg—Al—Mn-based alloys, Mn: 0.05% by mass or more and 0.5% by mass or less); AS-based alloys (Mg—Al—Si-based alloys, Si: 0.3% by mass or more and 4.0% by mass or less); Mg—Al-RE (rare earth element)-based alloy; AX-based alloys (Mg—Al—Ca-based alloys, Ca: 0.2% by mass or more and 6.0% by mass or less); AZX-based alloys (Mg—Al—Zn—Ca-based alloys, Zn: 0.2% by mass or more and 1.5% by mass or less, Ca: 0.1% by mass or more and 4.0% by mass or less); and AJ-based alloys (Mg—Al—Sr-based alloys, Sr: 0.2% by mass or more and 7.0% by mass or less).

Of these, AZ-based alloys including AZ10, AZ31, AZ61, AZ63, AZ80, AZ81, and AZ91 are preferred. In particular, an AZ91 alloy (a Mg—Al-based alloy containing 8.3% by mass or more and 9.5% by mass or less of Al and 0.5% by mass or more and 1.5% by mass or less of Zn) is preferable to other AZ-based alloys because higher specific strength, higher corrosion resistance, and higher mechanical properties are obtained.

Examples of the Al alloy include A5052 alloy (5000-based alloy).

When the hollow closed cross-section portion 2 is produced by combining two (plural) split pieces P1 and P2 as in the present example, the two (all the) split pieces P1 and P2 may be formed of the same material, or the material forming one (at least one) of the split pieces, e.g., the split piece P1, may differ from the material forming the other one of the split pieces, i.e., the split piece P2. For example, the split piece P1 may be formed of a Mg-based material, and the split piece P2 may be formed of an Al-based material.

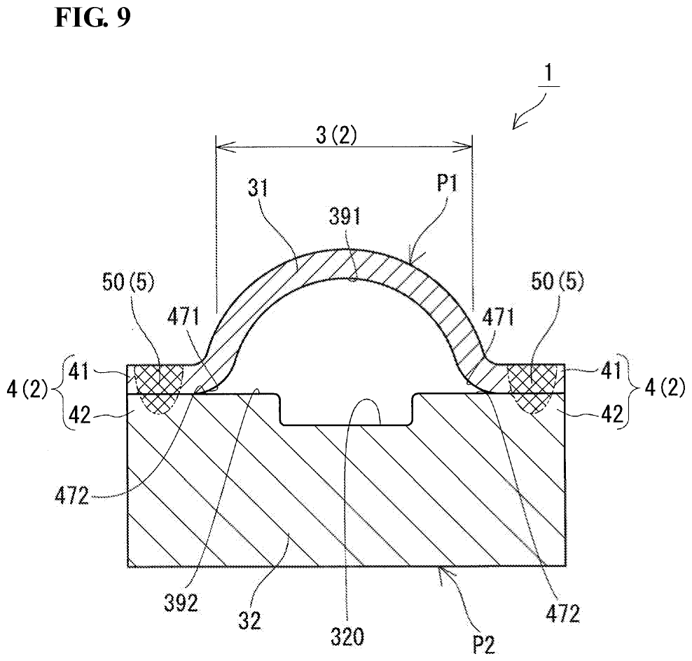

The two (all the) split pieces P1 and P2 may be each formed from a sheet. Alternatively, one (at least one) of the split pieces, e.g., the split piece P1, may be formed from a sheet, and the other one (one) of the split pieces, i.e., the split piece P2 may be formed from a block material (FIG. 9). The sheet used may be a die-cast material having a prescribed shape or a pressed material prepared by subjecting a flat cast material or a flat rolled material to press forming into a prescribed shape. Examples of the block material include die-cast materials.

To produce the hollow structure 1, a hollow structure production method is used, which includes: a preparation step of preparing the first split piece P1 and the second split piece P2; and a joining step of placing the first split piece P1 and the second split piece P2 such that their overhanging portions 41 and 42 face each other and then joining the overhanging portions 41 and 42 together. In the preparation step, the split pieces P1 and P2 having a prescribed shape may be produced by die casting or may be produced by subjecting sheets to press forming into a prescribed shape. In the joining step, each first overhanging portion 41 and the corresponding second overhanging portion 42 are disposed such that their side surfaces are aligned with each other. Then, in the present example, a friction stir welding tool (not shown) including a shoulder and a probe is rotated and moved in the longitudinal direction of the first overhanging portion 41 while pressure is applied to the surface of the first overhanging portion 41 to thereby friction-stir-weld the overhanging portions 41 and 42 together.

### [Applications]

The hollow structure 1 according to the embodiment can be preferably used for beam materials for automobiles that require stiffness.

### [Operational Advantage]

The hollow structure 1 according to embodiment 1 is excellent in flexural rigidity. Since the hollow closed cross-section portion 2 is formed by combining sheets, the shape flexibility is higher than that when extruded materials are used to form the hollow closed cross-section portion.

### <<Modifications>>

Modifications 1 to 16 of the hollow structure 1 according to embodiment 1 will be described. Hollow structures 1 in the modifications are the same as the hollow structure 1 in embodiment 1 in that the hollow closed cross-section portion 2 includes the main portion 3 and the flange portions 4 and that each flange portion 4 has the friction stir welded portion 50 (the joint portion 5). In each of the modifications, differences from embodiment 1 will be mainly described, and the description of the same structures will be omitted.

### [Modification 1]

As shown in FIG. 4, the hollow structure 1 in modification 1 differs from the hollow structure 1 in embodiment 1 in that the cross section of the inner space of the main portion 3 has a rectangular annular (rectangular) shape. FIG. 4 is a cross-sectional view showing the state in which the hollow structure 1 is cut at the same position as that of the cross-sectional view shown in FIG. 2. This also applies to FIGS. 5 to 9, 17, 18, and 23 to 25. The circumferential wall portions 31 and 32 of the first and second split pieces P1 and P2 each have a V-shaped cross sectional shape but may each have a square U-shaped cross sectional shape including three surrounding sides.

### [Modification 2]

As shown in FIG. 5, the hollow structure 1 in modification 2 differs from the hollow structure 1 in embodiment 1 in that the cross section of the inner space of the main portion 3 has a semi-circular annular (semi-circular) shape. The first split piece P1 is the same as the first split piece P1 in embodiment 1. However, the second split piece P2 has a flat plate shape with a rectangular cross section in which the circumferential wall portion 32 and the pair of second overhanging portions 42 are located in the same plane.

The cross section of the inner space of the main portion 3 may have a triangular annular (triangular) or rectangular annular (triangular) shape. Specifically, the circumferential wall portion 31 of the first split piece P1 may have a V cross-sectional shape, as in modification 1, or a square U-shaped cross sectional shape including three surrounding sides, and the second split piece P2 may have a plate shape, as in the present example.

### [Modification 3]

As shown in FIG. 6, the hollow structure 1 in modification 3 differs from the hollow structure 1 in embodiment 1 in that the clockwise circumferential distance between the two flange portions 4 differs from the counterclockwise circumferential distance. The flange portions 4 are not located in the same plane but are located such that an extension plane of the interface between the first overhanging portion 41 and the second overhanging portion 42 included in one of the flange portions 4 intersects an extension plane of the interface between the first overhanging portion 41 and the second overhanging portion 42 included in the other one of the flange portions 4. The cross section of the main portion 3 has a circular annular (circular) shape. The circumferential wall portion 31 of the first split piece P1 has an arcuate cross-sectional shape with a shorter arc length than a semi-circular arcuate cross-sectional shape, and the circumferential wall portion 32 of the second split piece P2 has an arcuate cross-sectional shape with a longer arc length than the semi-circular arcuate cross-sectional shape.

### [Modification 4]

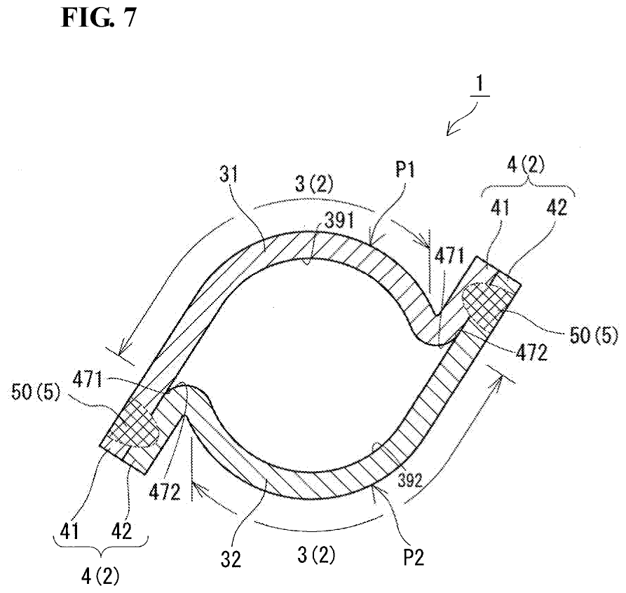

As shown in FIG. 7, the hollow structure 1 in modification 4 differs from the hollow structure 1 in embodiment 1 in that the two flange portions 4 are not located in the same plane. The flange portions 4 are located such that an extension plane of the interface between the first overhanging portion 41 and the second overhanging portion 42 included in one of the flange portions 4 is substantially parallel to an extension plane of the interface between the first overhanging portion 41 and the second overhanging portion 42 included in the other one of the flange portions 4. The cross section of the main portion 3 has a circular annular (circular) shape, and the cross sections of the circumferential wall portions 31 and 32 of the split pieces P1 and P2 each have a semi-circular arcuate shape. One of the first overhanging portions 41 (the left one in FIG. 7) of the first split piece P1 is formed linearly so as to extend from one end portion of the circumferential wall portion 31 along a tangential line of the end portion, and the other one of the first overhanging portions 41 (the right one in FIG. 7) is formed so as to intersect the other end portion of the circumferential wall portion 31.

One of the second overhanging portions 42 (the left one in FIG. 7) of the second split piece P2 is formed so as to intersect one end portion of the circumferential wall portion 32, and the other one of the second overhanging portions 42 (the right one in FIG. 7) is formed linearly so as to extend form the other end portion of the circumferential wall portion 32 along a tangential line of the other end portion.

### [Modification 5]

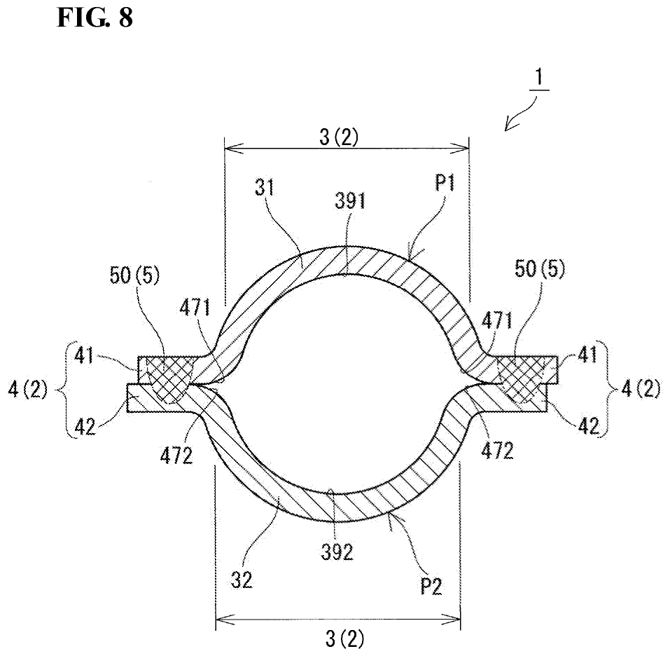

As shown in FIG. 8, the hollow structure 1 in modification 5 differs from the hollow structure 1 in embodiment 1 in that the first split piece P1 and the second split piece P2 are displaced from each other in the width direction of the flange portions 4. The split pieces P1 and P2 have the same shape and the same size. The side surfaces of the first overhanging portions 41 are not aligned with the respective side surfaces of the second overhanging portions 42, and each flange portion 4 has a step portion formed by the corresponding first overhanging portion 41 and the corresponding second overhanging portion 42. The width W1 of the flange portion is as described in embodiment 1. The total width W2 that is the sum of the width A of the joint portion 5 and the width of the contact portion 6 is the width of the overlapping region of the first overhanging portion 41 and the second overhanging portion 42. Specifically, in the flange portion 4 on the left side in the drawing sheet of FIG. 8, the total width W2 does not include the width of a portion of the second overhanging portion 42 that protrudes from the side surface of the first overhanging portion 41. This is also the case for the flange portion 4 on the right side in the drawing sheet of FIG. 8.

### [Modification 6]

As shown in FIG. 9, the hollow structure 1 in modification 6 differs from the hollow structure 1 in embodiment 1 in that the second split piece P2 is formed from a rectangular block material thicker than the first split piece P1. This block material may be formed of a die-cast material. A recess 320 is formed on the inner surface of the circumferential wall portion 32 of the second split piece P2. However, the recess 320 may not be formed, and the recess may have a cross-sectional shape other than the rectangular shape.

### [Modification 7]

As shown in FIG. 10, the hollow structure 1 in modification 7 differs from the hollow structure 1 in embodiment 1 in that each of the flange portions 4 has a notch 45. No particular limitation is imposed on the shape and size of the notches 45, the number of notches 45, and the formation positions of the notches 45. For example, they may be appropriately selected such that the hollow structure 1 does not interfere with a peripheral member. In the present example, the notches have a rectangular shape but may have a triangular shape, a trapezoidal shape, or a semi-circular shape. In the present example, the numbers of notches 45 in the respective flange portions 4 are the same and are 1. However, a plurality of notches 45 may be provided for each of the flange portions 4, and the numbers of notches 45 in the respective flange portions 4 may differ from each other. No notch 45 may be provided for one of the flange portions 4, and a notch 45 may be provided only for the other one of the flange portions 4. In the present example, the formation position of a notch 45 in one of the flange portions 4 differs from the formation position of a notch 45 in the other one of the flange portions 4. Specifically, the notch 45 in one of the flange portions 4 is formed on one side in the longitudinal direction, and the notch 45 in the other one of the flange portions 4 is formed on the other side in the longitudinal direction. However, the notches 45 may be formed at central positions, with respect to the longitudinal direction, of the flange portions 4 or on the same side in the longitudinal direction. Preferably, the hollow structure 1 having the notches 45 is produced by producing the hollow structure 1 in FIG. 1 with no notches and then die-cutting part of the flange portions.

### [Modification 8]

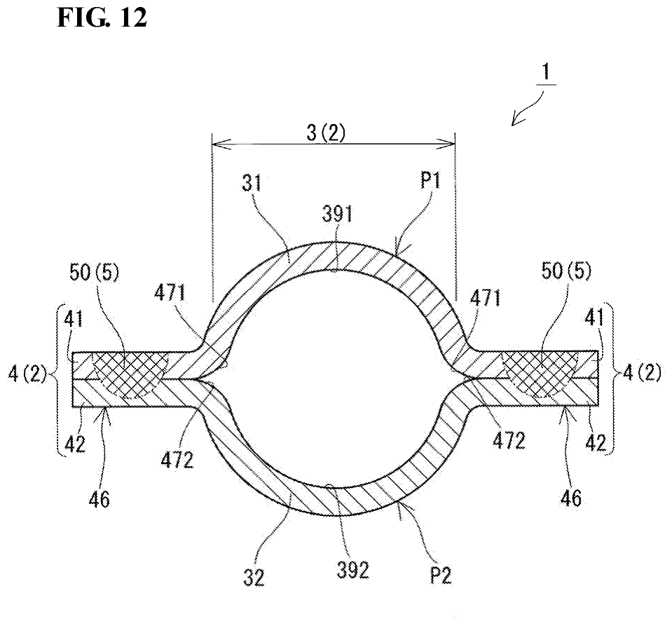

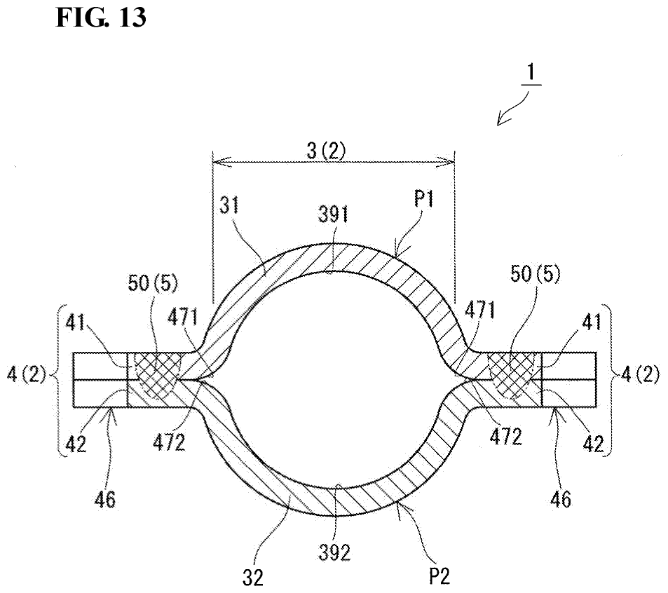

As shown in FIGS. 11 to 13, the hollow structure 1 in modification 8 differs from the hollow structure 1 in embodiment 1 in that each of the flange portions 4 has a wide portion 46 with a locally larger width. The cross-sectional shape of the inner space of the main portion 3 is uniform in the longitudinal direction. No particular limitation is imposed on the shape and size of the wide portions 46, the number of wide portions 46, and the formation positions of the wide portions 46. In the present example, the wide portions 46 have a semi-circular shape but may have a triangular shape, a rectangular shape, or a trapezoidal shape. In the present example, the numbers of wide portions 46 in the respective flange portions 4 are the same and are 1. However, a plurality of wide portions 46 may be provided for each of the flange portions 4, and the numbers of wide portions 46 in the respective flange portions 4 may differ from each other. No wide portion 46 may be provided for one of the flange portions 4, and a wide portion 46 may be provided only for the other one of the flange portions 4. In the present example, the wide portions 46 are formed at central positions, with respect to the longitudinal direction, of the flange portions 4. However, the wide portion 46 formed in one of the flange portions 4 and the wide portion formed in the other one of the flange portions 4 may be located on different sides in the longitudinal direction or on the same side. In the joint portions 5 of the wide portions 46 of the flange portions 4, as in the joint portions 5 of the other portions, the width ratio A/W1 satisfies the above-described range, so that the joint portions 5 of the wide portions 46 are wider than the joint portions 5 of the other portions (FIGS. 12 and 13). Preferably, these wide portions 46 are formed by moving a friction stir welding tool along parallel portions to increase the width of the joint portions 5. In this manner, the joint strength of the wide portions 46 can be increased.

### [Modification 9]

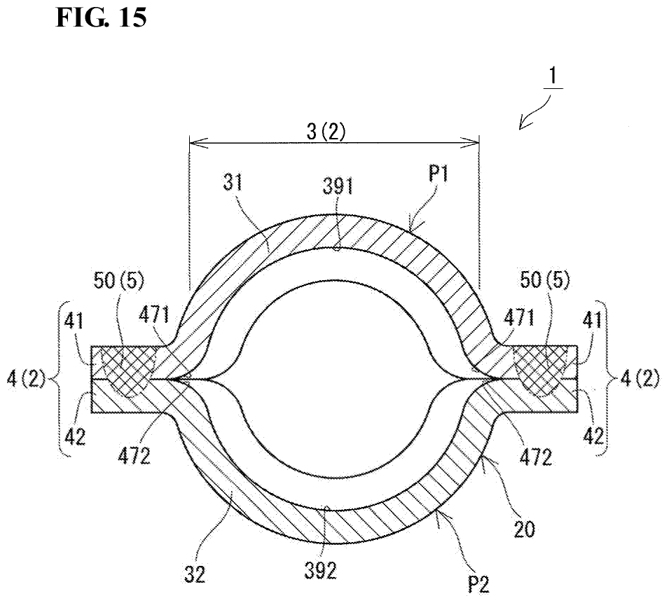

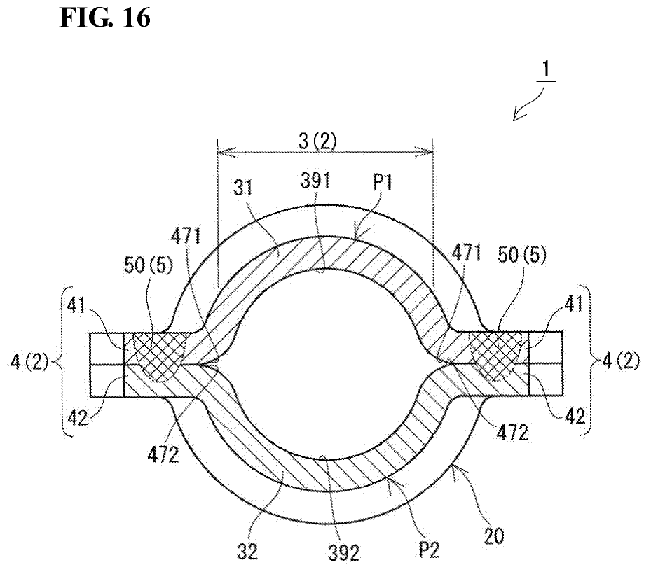

As shown in FIGS. 14 to 16, the hollow structure 1 in modification 9 differs from the hollow structure 1 in embodiment 1 in that the hollow closed cross-section portion 2 has an enlarged portion 20 in which the inner space of the main portion 3 has a locally larger cross-sectional area. The enlarged portion 20 has a spherical segment shape. The main portion 3 in the enlarged portion 20 has a circular annular cross-sectional shape that is the same as the cross-sectional shape of the main portion 3 around the enlarged portion 20, but the cross-sectional area of the main portion 3 in the enlarged portion 20 is larger than the cross-sectional area of the main portion 3 around the enlarged portion 20. Specifically, the cross section of the main portion 3 has a circular annular shape that is uniform in the longitudinal direction, but the cross-sectional area of the main portion 3 is not uniform in the longitudinal direction. The cross-sectional shape and cross-sectional area of the flange portions 4 in the enlarged portion 20 are the same as the rectangular cross-sectional shape and cross-sectional area of the flange portions 4 around the enlarged portion 20. Specifically, the cross-sectional shape of the flange portions 4 is rectangular and is uniform in the longitudinal direction, and the cross-sectional area of the flange portions 4 is uniform in the longitudinal direction.

### [Modification 10]

As shown in FIG. 17, the hollow structure 1 in modification 10 differs from the hollow structure 1 in embodiment 1 in that the number of flange portions 4 is three or more (four in the present example). The circumferential distances between adjacent flange portions 4 are the same. The cross section of the main portion 3 has a circular annular shape that is the same as the cross-sectional shape of the main portion 3 in embodiment 1. The hollow structure 1 is composed of a combination of four split pieces (a first split piece P1 to a fourth split piece P4) having the same shape and the same size. Circumferential wall portions 31 to 34 of the split pieces P1 to P4 each have a substantially quarter arc-shaped cross section. One of first overhanging portions 41 of the first split piece P1 is disposed so as to face one of second overhanging portions 42 of the second split piece P2, and the other one of the second overhanging portions 42 of the second split piece P2 is disposed so as to face one of third overhanging portions 43 of the third split piece P3. The other one of the third overhanging portions 43 of the third split piece P3 is disposed so as to face one of fourth overhanging portions 44 of the fourth split piece P4, and the other one of the fourth overhanging portions 44 of the fourth split piece P4 is disposed so as to face the other one of the first overhanging portions 41 of the first split piece P1.

### [Modification 11]

As shown in FIG. 18, the hollow structure 1 in modification 11 differs from the hollow structure 1 in embodiment 1 in that the number of flange portions 4 is one. This hollow structure 1 is formed from one sheet and includes: a C-shaped circumferential wall portion 31 forming the main portion 3 of the hollow closed cross-section portion 2; and first and second overhanging portions 41 and 42 that are continuous with opposite end portions of the circumferential wall portion 31 and form a flange portion 4. Specifically, the first overhanging portion 41 and the second overhanging portion 42 are formed from a single member with the circumferential wall portion 31 therebetween.

### [Modification 12]

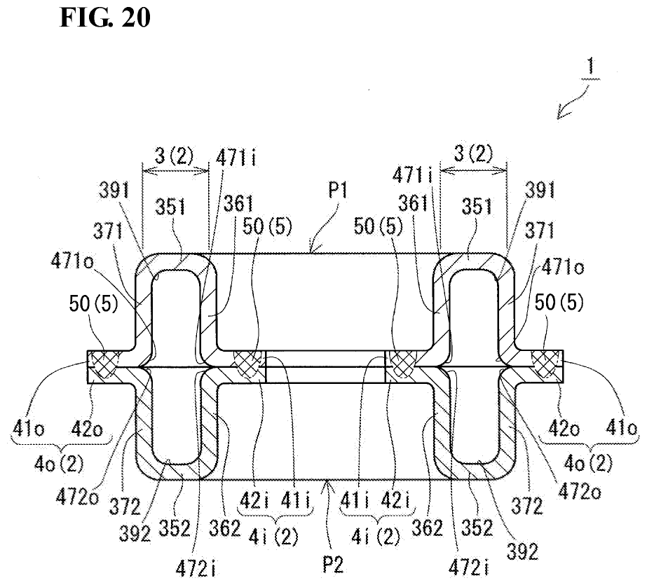

As shown in FIGS. 19 and 20, the hollow structure 1 in modification 12 differs from the hollow structure 1 in embodiment 1 in that the hollow closed cross-section portion 2 has an annular shape. A projection shape of the hollow structure 1 when it is viewed in the axial direction of the annular shape is a rectangular annular shape in the present example but may be a circular annular shape, an elliptical annular shape, or a polygonal annular shape such as a triangular annular shape other than the rectangular annular shape. Specifically, a through hole is formed at the center of the hollow structure 1. The hollow closed cross-section portion 2 includes: a rectangular annular main portion 3; an inner flange portion 4i protruding inward from the inner circumference of the main portion 3; and an outer flange portion 4o protruding outward from the outer circumference of the main portion 3. The cross-sectional of the inner space of the main portion 3 is uniform in the longitudinal direction and is a rectangular annular shape (rectangular shape). The first split piece P1 of the hollow structure 1 includes: a rectangular annular bottom portion 351; an inner circumferential wall portion 361 erected from the inner circumferential edge of the bottom portion 351; an outer circumferential wall portion 371 erected from the outer circumferential edge of the bottom portion 351; a first inner overhanging portion 41i protruding inward from an end surface of the inner circumferential wall portion 361; and a first outer overhanging portion 410 protruding outward from an end surface of the outer circumferential wall portion 371. The first inner overhanging portion 41i is formed over the entire end surface of the inner circumferential wall portion 361, and the first outer overhanging portion 410 is formed over the entire end surface of the outer circumferential wall portion 371. The second split piece P2 includes a bottom portion 352, an inner circumferential wall portion 362, an outer circumferential wall portion 372, a second inner overhanging portion 42i, and a second outer overhanging portion 42o that are similar to those of the first split piece P1. The first outer overhanging portion 410 has an outer first surface 4710 continuous with an inner circumferential surface 391. The first inner overhanging portion 41i has an inner first surface 471i continuous with the inner circumferential surface 391. The second outer overhanging portion 42o has an outer second surface 472o continuous with the inner circumferential surface 391. The second inner overhanging portion 42i has an inner second surface 472i continuous with the inner circumferential surface 391.

### [Modification 13]

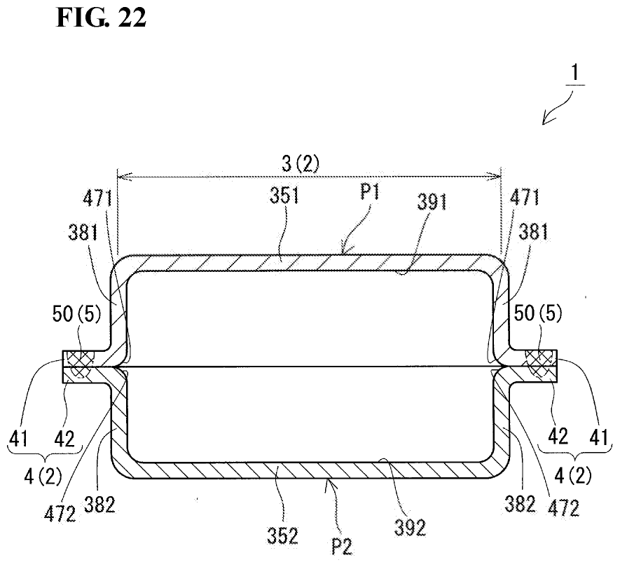

As shown in FIGS. 21 and 22, the hollow structure 1 in modification 13 differs from the hollow structure 1 in embodiment 1 in that the hollow closed cross-section portion 2 has a box shape. The hollow closed cross-section portion 2 has a quadrangular prismatic shape in the present example but may have a different prismatic shape or a cylindrical shape. The hollow closed cross-section portion 2 includes: a main portion 3 having a rectangular container shape; and a flange portion 4 protruding outward from the outer circumference of the main portion 3. The inner space of the main portion 3 has a quadrangular prismatic shape that is the same as the shape of the hollow closed cross-section portion 2. The first split piece P1 of the hollow structure 1 includes: a rectangular bottom portion 351; a side wall portion 381 erected from the outer circumferential edge of the bottom portion 351; and a first overhanging portion 41 protruding radially outward from an end surface of the side wall portion 381. The first overhanging portion 41 is formed over the entire end surface of the side wall portion 381. The second split piece P2 includes a bottom portion 352, a side wall portion 382, and a second overhanging portion 42 that are similar to those in the first split piece P1.

### [Modification 14]

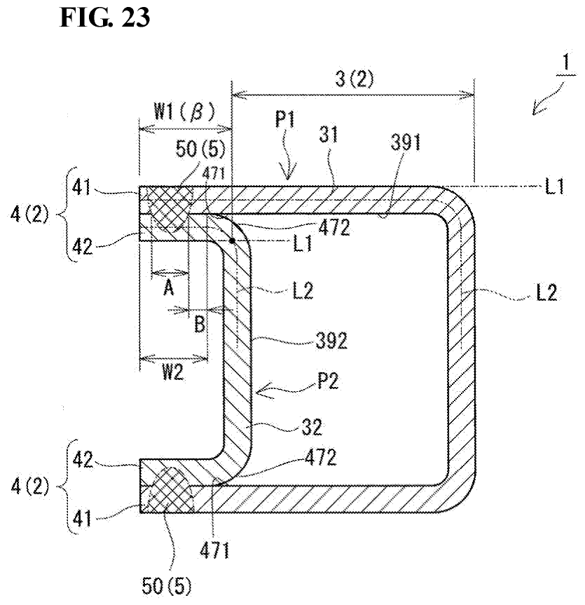

As shown in FIG. 23, the hollow structure 1 in modification 14 differs from the hollow structure 1 in embodiment 1 mainly in that the cross section of the inner space of the main portion 3 has a rectangular annular (rectangular) shape and that the two flange portions 4 are not present in the same plane and protrude in the same direction.

The first split piece P1 and the second split piece P2 have similar shapes and are formed from respective square U-shaped sheets each having three flat surrounding surfaces. The cross-sectional shape of the first split piece P1 is larger than the cross-sectional shape of the second split piece P2. The first split piece P1 includes: a square U-shaped circumferential wall portion 31 having three flat surrounding surfaces; and a pair of first overhanging portions 41 extending linearly from opposite ends of the circumferential wall portion 31. The number of bent portions of the circumferential wall portion 31 is two, and the circumferential wall portion 31 has two parallel flat surfaces and a flat surface that is orthogonal to the two flat surfaces and connects ends of the two parallel surfaces. The pair of first overhanging portions 41 are parallel to each other. The second split piece P2 includes: a circumferential wall portion 32; and a pair of second overhanging portions 42 protruding radially outward from opposite ends of the circumferential wall portion 32 so as to intersect the circumferential wall portion 32 (orthogonally, in the present example). The pair of second overhanging portions 42 are parallel to each other and also parallel to the pair of first overhanging portions 41. Since the overhanging portions 41 and 42 are flat and disposed parallel to each other, they can be in surface contact with each other, and the width A of joint portions 5 can be easily increased. The two flange portions 4 may not be parallel to each other.

An opening of the first split piece P1 and an opening of the second split piece P2 face the same direction, and the first split piece P1 and the second split piece P2 are combined such that the pair of second overhanging portions 42 are disposed on the inner side of the pair of the first overhanging portions 41. Specifically, among the four sides of a rectangular cross section of the main portion 3, three sides are formed from the circumferential wall portion 31 of the first split piece P1, and the remaining one side is formed from the circumferential wall portion 32 of the second split piece P2. One of the first overhanging portions 41 and one of the second overhanging portions 42 are disposed so as to face each other, and the other one of the first overhanging portions 41 and the other one of the second overhanging portions 42 are disposed so as to face each other. Preferably, the distance between the two flange portions 4 and the width W1 of the flange portions 4 are set such that a friction stir welding tool and a support member that faces the tool with one of the flange portions 4 therebetween can be disposed on the one of the flange portions 4 without interference with the other one of the flange portions 4. Since the flange portions 4 protrude in the same direction from the hollow structure 1, the joining operation can be performed on the flange portions 4 from the same direction. This is also the case for modifications 15 and 16 described later. In the present example, the side surfaces of the first split piece P1 and the side surfaces of the second split piece P2 are aligned with each other but may be displaced from each other in the width direction of the flange portions 4.

### [Modification 15]

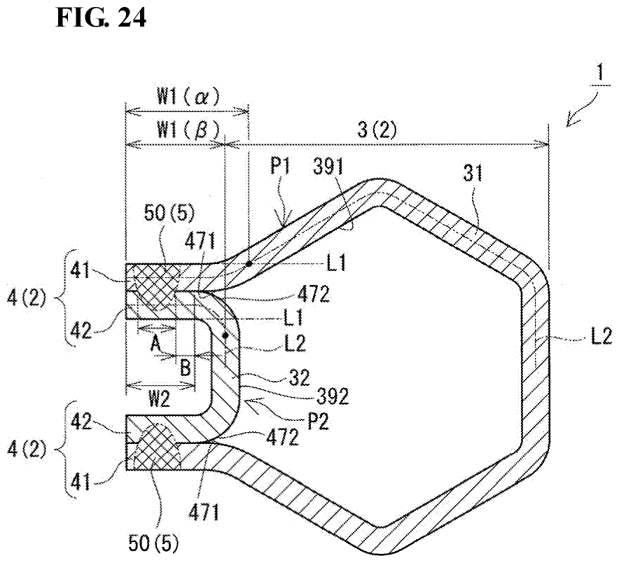

As shown in FIG. 24, the hollow structure 1 in modification 15 differs from the hollow structure 1 in embodiment 1 in that the cross section of the inner space of the main portion 3 has a hexagonal annular (hexagonal) shape and that the two flange portions 4 are not present in the same plane and protrude in the same direction.

The first split piece P1 and the second split piece P2 have different shapes. The second split piece P2 is the same as the second split piece P2 in modification 14. Specifically, the second split piece P2 is formed from a square U-shaped sheet having three flat surrounding surfaces and includes a circumferential wall portion 32 and a pair of second overhanging portions 42 having a rectangular cross-sectional shape and protruding radially outward from opposite ends of the circumferential wall portion 32 so as to intersect the circumferential wall portion 32 (orthogonally, in the present example). The first split piece P1 includes: a circumferential wall portion 31 having a C-shaped cross section with a plurality of bent portions; and a pair of first overhanging portions 41 protruding radially outward and each having a rectangular cross section. Although the number of bent portions of the circumferential wall portion 31 of the first split piece P1 in modification 14 is two, the number of bent portions of the circumferential wall portion 31 of the first split piece P1 in the present example is four. The pair of first overhanging portions 41 are parallel to each other and also parallel to the pair of the second overhanging portion 42. The two flange portions 4 may not be parallel to each other.

An opening of the first split piece P1 and an opening of the second split piece P2 face in the same direction, and the first split piece P1 and the second split piece P2 are combined such that the pair of second overhanging portions 42 are disposed on the inner side of the pair of the first overhanging portions 41, as in modification 14. In the present example, among the six sides of the hexagonal cross section of the main portion 3, five sides are formed from the circumferential wall portion 31 of the first split piece P1, and the remaining one side is formed from the circumferential wall portion 32 of the second split piece P2. One of the first overhanging portions 41 and one of the second overhanging portions 42 are disposed so as to face each other, and the other one of the first overhanging portions 41 and the other one of the second overhanging portions 42 are disposed so as to face each other. In the present example, the side surfaces of the first split piece P1 and the side surfaces of the second split piece P2 are aligned with each other but may be displaced from each other in the width direction of the flange portions 4. In the present example, the width β is shorter than the width α. Specifically, in the present example, the width W1 of the flange portions 4 is the width β.

Moreover, although not illustrated, the cross section of the inner space of the main portion 3 may have a polygonal annular (polygonal) shape other than the rectangular annular (rectangular) and hexagonal annular (hexagonal) shapes described above. Examples of the polygonal annular (polygonal) shape include a triangular annular (triangular) shape, a pentagonal annular (pentagonal) shape, and an octagonal annular (octagonal) shape. The number of bent portions in the circumferential wall portion 31 of the first split piece P1 is two when the cross section of the main portion 3 has a rectangular annular shape (four when cross section of the main portion 3 has a hexagonal annular shape). The cross section of the main portion 3 has a triangular shape (the circumferential wall portion 31 has a V shape) when the number of bent portions is one, has a pentagonal annular shape (the circumferential wall portion 31 has a C shape) when the number of bent portions is three, and has an octagonal annular shape (the circumferential wall portion 31 has a C shape) when the number of bent portions is six.

### [Modification 16]

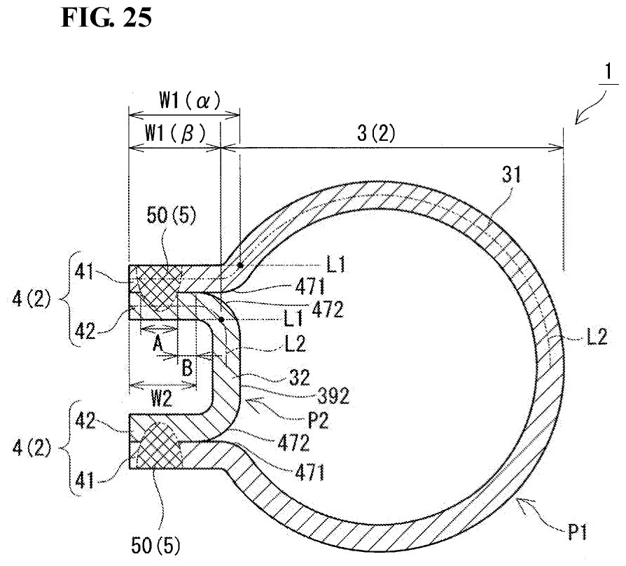

As shown in FIG. 25, the hollow structure 1 in modification 16 differs from the hollow structure 1 in embodiment 1 in that the cross section of the inner space of the main portion 3 has a bow-like annular (bow-like) shape including a bowstring and an arc and that the two flange portions 4 are not present in the same plane and protrude in the same direction.

The first split piece P1 and the second split piece P2 have different shapes. The second split piece P2 is the same as the second split piece P2 in modification 14. Specifically, the second split piece P2 is formed from a square U-shaped sheet having three flat surrounding surfaces and includes a circumferential wall portion 32 having a rectangular cross-sectional shape and a pair of second overhanging portions 42 having a rectangular cross-sectional shape and protruding radially outward from opposite ends of the circumferential wall portion 32 so as to intersect the circumferential wall portion 32 (orthogonally, in the present example). The first split piece P1 includes: a circumferential wall portion 31 having an arcuate cross-sectional shape (a C-shaped cross-sectional shape with no bent portion) with a longer arc length than a semi-circular arcuate shape; and a pair of first overhanging portions 41 having a rectangular cross-sectional shape and protruding radially outward from opposite ends of the circumferential wall portion 31. The pair of first overhanging portions 41 are parallel to each other and also parallel to the pair of second overhanging portions 42. The two flange portions 4 may not be parallel to each other.

An opening of the first split piece P1 and an opening of the second split piece P2 face in the same direction, and the first split piece P1 and the second split piece P2 are combined such that the pair of second overhanging portions 42 are disposed on the inner side of the pair of the first overhanging portions 41, as in modifications 14 and 15. In the present example, among the bowstring and the arc that form the bow-like cross section and also form the main portion 3, the bowstring is formed from the circumferential wall portion 32 of the second split piece P2, and the arc is formed from the circumferential wall portion 31 of the first split piece P1. One of the first overhanging portions 41 and one of the second overhanging portions 42 are disposed so as to face each other, and the other one of the first overhanging portions 41 and the other one of the second overhanging portions 42 are disposed so as to face each other. In the present example, the side surfaces of the first split piece P1 and the side surfaces of the second split piece P2 are aligned with each other but may be displaced from each other in the width direction of the flange portions 4. In the present example, the width β is shorter than the width α. Specifically, in the present example, the width W1 of the flange portions 4 is the width β.

Moreover, the cross section of the inner space of the main portion 3 may have, for example, a semi-circular annular (semi-circular) shape. When the first split piece P1 has a semi-circular shape, the main portion 3 can have a semi-circular annular cross-sectional shape.

### Test Examples

The hollow structure described with reference to FIGS. 1 to 3 was produced, and its flexural rigidity was evaluated.

For samples Nos. 1-1 to 1-3 and 1-101 to 1-103, the first and second split pieces having the same shape and the same size were prepared. Each of the split pieces includes: a circumferential wall portion having a semi-circular cross section; and a pair of overhanging portions having a rectangular cross section (see FIGS. 1 and 2 appropriately). The materials of the split pieces are as shown in Table 1.

The overhanging portions of the split pieces were disposed so as to face each other with their side surfaces aligned with each other and were joined together by friction stir welding, as shown in FIG. 2. A hollow structure was thereby produced. The hollow structure has a hollow closed cross-section portion including a main portion formed from the two circumferential wall portions and a pair of flange portions formed from the overhanging portions of the two split pieces. The cross section of the main portion has a circular annular shape. The outer diameter (mm) of the main portion of the hollow closed cross-section portion, the width W1 (mm) of the flange portions, the thickness (mm) of the flange portions, the width A (mm) of the joint portions, the length (mm) of the joint portions, and the width B (mm) of the inner contact portions are as shown in Table 1 (see FIG. 3 for the widths).

### [Evaluation of Flexural Rigidity]

The flexural rigidity of each sample was evaluated by a three-point bending test. Specifically, the joint state between the first overhanging portion and second overhanging portion of each flange portion was checked. The load was applied to the center of the main portion in its longitudinal direction so as to act in a direction orthogonal to the longitudinal direction and to the width direction of the flange portions. The load was 2,000 N. The test speed was 6 mm/min, and the length of the support span was 350 mm. The results are shown in Table 1. “Good” in the table means that the stiffness is 50% or more of the value of the stiffness computed based on the assumption that the flange portion is completely joined over the entire width W1. “Bad” means that the stiffness is less than 50% of the computational value.

TABLE 1

| | | | Main | | | | | | | | Inner | | |
|---|---|---|---|---|---|---|---|---|---|---|---|---|---|
| | | | portion | | | | Joint | | | | contact | | |
| | Material | | Outer | Flange portion | | | portion | | | | portion | | |
| Sample | First split | Second spilt | diameter | Width W1 | Length | Thickness | Width A | Length | | | Width B | | Flexural |
| No. | piece | piece | (mm) | (mm) | (mm) | (mm) | (mm) | (mm) | A/W1 | A/W2 | (mm) | B/W2 | rigidity |
| 1-1 | AZ91 | AZ91 | 40 | 23 | 350 | 6 | 10 | 350 | 0.43 | 0.56 | 5 | 0.28 | Good |
| 1-2 | AZ91 | AZ91 | 40 | 13 | 350 | 6 | 4.8 | 350 | 0.37 | 0.62 | 3 | 0.38 | Good |
| 1-3 | A5052 | A5052 | 40 | 23 | 350 | 6 | 10 | 350 | 0.43 | 0.56 | 5 | 0.28 | Good |
| 1-101 | AZ91 | AZ91 | 40 | 23 | 350 | 6 | 2 | 350 | 0.09 | 0.11 | 15.8 | 0.89 | Bad |
| 1-102 | AZ91 | AZ91 | 40 | 13 | 350 | 6 | 2 | 350 | 0.15 | 0.26 | 5.8 | 0.74 | Bad |
| 1-103 | A5052 | A5052 | 40 | 23 | 350 | 6 | 2 | 350 | 0.09 | 0.11 | 15.8 | 0.89 | Bad |

As shown in Table 1, in the hollow structure samples Nos. 1-1 to 1-3, the flexural rigidity is better than that of the hollow structure samples Nos. 1-101 to 1-103.

The present invention is not limited to the above examples but is defined by the claims. The present invention is intended to cover any modifications within the scope of the claims and meaning equivalent to the scope of the claims.

### REFERENCE SIGNS LIST

1 hollow structure
2 hollow closed cross-section portion
20 enlarged portion
3 main portion
31, 32, 33, 34 circumferential wall portion
320 recess
351, 352 bottom portion
361, 362 inner circumferential wall portion
371, 372 outer circumferential wall portion
381, 382 side wall portion
391, 392 inner circumferential surface
4 flange portion
4i inner flange portion
4o outer flange portion
41 first overhanging portion
41i first inner overhanging portion
41o first outer overhanging portion
42 second overhanging portion
42i second inner overhanging portion
42o second outer overhanging portion
43 third overhanging portion
44 fourth overhanging portion
45 notch
46 wide portion
471 first surface
471i inner first surface
471o outer first surface
472 second surface
472i inner second surface
472o outer second surface
473 third surface
474 fourth surface
5 joint portion
50 friction stir welded portion
6 contact portion
61 inner contact portion
62 outer contact portion
P1 first split piece
P2 second split piece
P3 third split piece
P4 fourth split piece

1. A hollow structure comprising:
a main portion having an inner circumferential surface; and
a flange portion including a first overhanging portion and a second overhanging portion that protrude outward from an outer circumference of the main portion and face each other,
wherein a first surface of the first overhanging portion and a second surface of the second overhanging portion are continuous with the inner circumferential surface,
wherein the flange portion has a joint portion at which the first surface and the second surface are joined together,
wherein the main portion and the flange portion are formed of a metal material composed mainly of a light metal, and
wherein the formula ⅕<A/W1 is satisfied, where W1 is the width of the flange portion, and A is the width of the joint portion.

2. The hollow structure according to claim 1,
wherein the flange portion has a contact portion in which the first overhanging portion and the second overhanging portion are not joined together but are in contact with each other, and
wherein the formula ¼<A/W2 is satisfied, where W2 is the sum of the width A of the joint portion and the width of the contact portion.

3. The hollow structure according to claim 2,
wherein the contact portion includes an inner contact portion formed closer to the main portion than the joint portion, and
wherein the formula B/W2<⅗ is satisfied, where B is the width of the inner contact portion.

4. The hollow structure according to claim 1,
wherein the length of the joint portion is 30% or more of the total length of the flange portion.

5. The hollow structure according to claim 1,
wherein the joint portion includes a friction stir welded portion at which the first overhanging portion and the second overhanging portion are joined together by friction stir welding.

6. The hollow structure according to claim 1,
wherein the hollow structure has at least one of an enlarged portion in which a space formed by the inner circumferential surface has a larger cross-sectional area and a reduced portion in which the space formed by the inner circumferential surface has a locally smaller cross-sectional area.

7. The hollow structure according to claim 1,
wherein the flange portion includes a wide portion in which the flange portion has a locally larger width.

8. The hollow structure according to claim 1,
wherein the flange portion has a notch.

9. The hollow structure according to claim 1,
wherein the light metal is magnesium or aluminum.

10. The hollow structure according to claim 1,
wherein the light metal is an AZ91 alloy.
